(19) United States
(12) Patent Application Publication
(10) Pub. No.: US 2010/0270817 A1
(43) Pub. Date: Oct. 28, 2010

(54) COLLAPSIBLE DEVICE

(75) Inventor: XU-HUI YU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/490,338

(22) Filed: Jun. 24, 2009

(30) Foreign Application Priority Data
Apr. 28, 2009 (CN) 200910301917.4

(51) Int. Cl. E05C 19/16

(52) U.S. Cl. 292/251.5

(57) ABSTRACT

A collapsible device includes a cover unit and a base unit pivotably attached to the cover unit. The cover unit includes a cover and a frame. The frame includes a recessed potion. A first sidewall, a second sidewall, a third sidewall, and a block extend from the recessed portion. The second sidewall and the third sidewall form an elastic hook respectively. A magnetic member is mounted to the frame and among the first to third sidewalls, and resisted by the hooks. A magnetic attracting member is mounted to the base unit according to the magnetic member and absorbable to the magnetic member.

### BACKGROUND

1. Technical Field

The present disclosure relates to a collapsible device.

2. Description of Related Art

Generally, a collapsible device, such as a portable computer, includes a cover unit, a base unit pivotably connected with the cover unit, and a latch mechanism provided to lock the cover unit to the base unit.

The latch mechanism usually includes a magnet mounted in the cover unit, for latching the cover unit to the base unit. The magnet is usually adhered to the cover unit by an adhesive. However, over time, aging of the adhesive may cause the magnet to fall off.

### BRIEF DESCRIPTION OF THE DRAWINGS

FIG. 1 is an isometric view of an embodiment of a collapsible device, the collapsible device includes a base unit including a frame, a cover unit, and a magnetic member.

FIG. 2 is an exploded, isometric view of the frame and the magnetic member of FIG. 1.

FIG. 3 is an enlarged view of the circled part III of FIG. 2.

FIG. 4 is an assembled view of FIG. 3.

### DETAILED DESCRIPTION

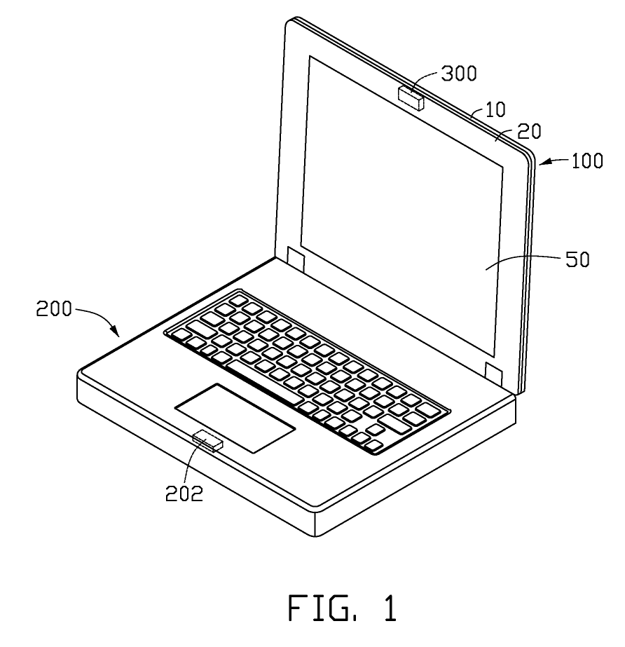

Referring to FIG. 1, an embodiment of a collapsible device, such as a notebook computer, includes a cover unit 100, a base unit 200, a magnetic member 300 and a magnetic attracting member 202. The cover unit 100 includes a cover 10 and a frame 20 mounted to the cover 10. A bottom side of the cover unit 100 is pivotably connected to the base unit 200 via hinges (not shown in FIGs). A liquid crystal display (LCD) panel 50 is arranged between the frame 20 and the cover 10. The magnetic member 300 is mounted to a top side opposite to the bottom side of the cover unit 100. The magnetic attracting member 202 is mounted to a side opposite to the hinges of the base unit 200.

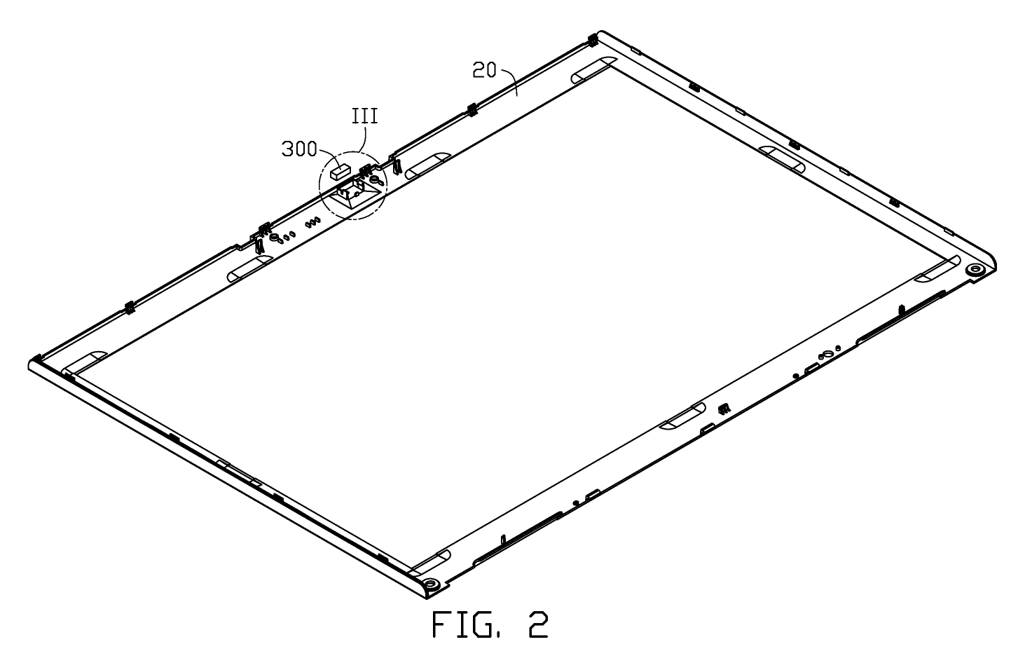

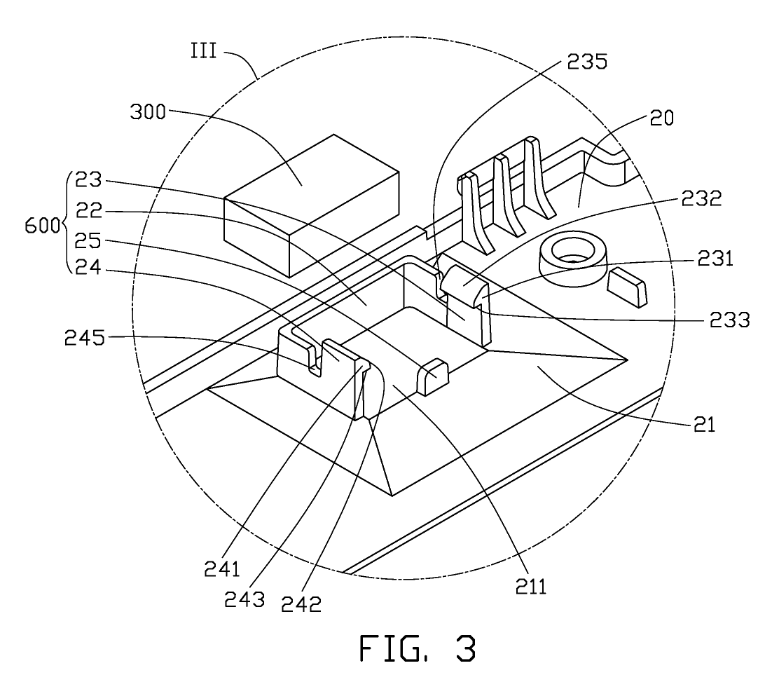

Referring to FIGS. 2 and 3, a recessed portion 21 is defined in a surface of the frame 20, facing the cover 10. The recessed portion 21 includes a bottom wall 211. A locking apparatus 600 is arranged on the bottom wall 211. The locking apparatus 600 and the bottom wall 211 form a receiving space for receiving the magnetic member 300.

The locking apparatus 600 includes a generally U-shaped first sidewall 22, a second sidewall 23, a third sidewall 24 and a block 25. The first sidewall 22 extends perpendicularly from the bottom wall 211. The second and third sidewalls 23, 24 extends perpendicularly from the bottom wall 211 respectively attached at opposite ends of the first sidewall 22. The block 25 extends from the bottom wall 211 and parallel to the first sidewall 22. A first elastic hook 231 extends from a distal end of the second sidewall 23. The first elastic hook 231 includes an inclined guiding portion 232 facing the third sidewall 24, and a blocking portion 233 facing the bottom wall 211. A second elastic hook 241 extends from a distal end of the third sidewall 24. The second elastic hook 241 includes an inclined guiding portion 242 facing the second sidewall 23, and a blocking portion 243 facing the bottom wall 211. A first cutout 235 is defined in the second sidewall 23 in the vicinity of the first hook 231, for adding elastic deformation quality to the first elastic hook 231. Similarly a second cutout 245 is defined in the third sidewall 24 in the vicinity of the second elastic hook 241, for adding elastic deformation quality to the second elastic hook 241.

The magnetic member 300 may be made of permanent magnetic materials, such as a ferromagnetic material, or a Al—Ni—Co system magnetic material, for example. It may be understood that the magnetic member 300 may be an electromagnet made of soft magnetic materials, such as silicon steel sheets, and may be magnetized or demagnetized by a control circuit.

The magnetic attracting member 202 may be made of magnetic absorbing materials, such as iron, cobalt, nickel, or alloys made of two or three of said magnetic absorbing materials, for example.

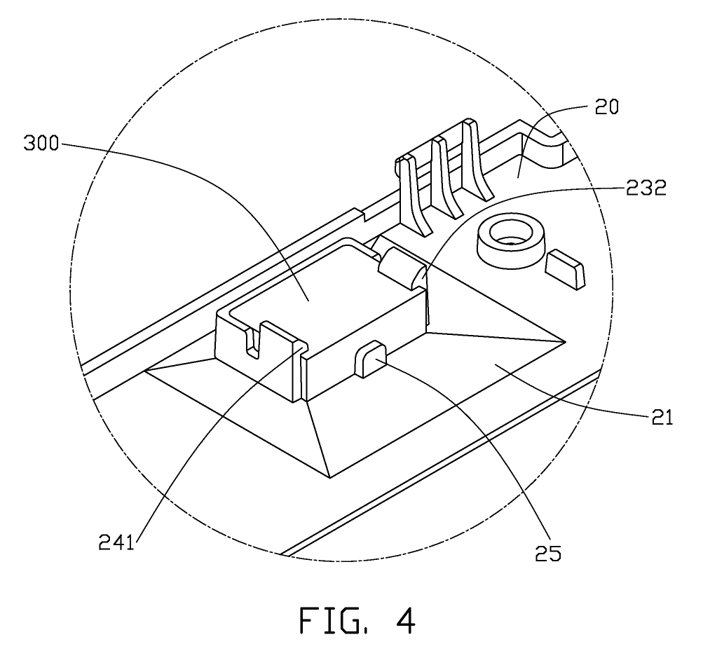

Referring to FIG. 4, in assembly, the magnetic member 300 is placed among the first to third sidewalls 22, 23, 24. The magnetic member 300 is driven to move towards the bottom wall 211 along the guiding portion 232 of the second sidewall 23 and the guiding portion 242 of the third sidewall 24. The first and second elastic hooks 231, 241 are deformed out, until the magnetic member 300 enters into the receiving space and is resisted by the blocking portions 233, 243. Therefore, the magnetic member 300 is mounted to the frame 20. The cover 10 is attached to the frame 20 to form the cover unit 100. The cover unit 100 is pivoted towards the base unit 200, until the magnetic member 300 is absorbed to the magnetic attracting member 202 to latch the cover unit 100 to the base unit 200.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A collapsible device, comprising:
a cover unit comprising a cover and a frame mounted to the cover, the frame defining a recessed potion, a first sidewall extending from the recessed portion, a second sidewall extending from the recessed portion, a third sidewall extending from the recessed portion, and a block extending from the recessed portion, the second and third sidewalls each comprising an elastic hook;
a base unit pivotably attached to the cover unit;
a magnetic member mounted to the frame and between the cover and the frame, wherein the magnetic member is located among the first to third sidewalls, and the block of the cover unit, and is resisted by the elastic hooks of the second and third sidewalls; and
a magnetic attracting member mounted to the base unit according to the magnetic member and absorbable to the magnetic member.

2. The collapsible device of claim 1, wherein the recessed portion comprises a bottom wall opposite to the hooks of the second and third sidewalls, the first sidewall extending from a first side of the bottom wall, the second sidewall extends from a first end of the bottom wall, the third sidewall extending from a second end of the bottom wall, and the block extending from a second side of the bottom wall.

3. The collapsible device of claim 2, wherein each elastic hook comprises a guiding portion facing an opposite one of the second and third sidewalls, and a blocking portion facing the bottom wall.

4. The collapsible device of claim 3, wherein a cutout is defined in each of the second and third sidewalls in the vicinity of the corresponding hook, for adding the elastic deformation of the elastic hook.

5. A locking apparatus for locking a magnetic member to a collapsible device with a frame, comprising:
a first sidewall extending from the frame;
a second sidewall extending from the frame perpendicularly to the first sidewall, wherein the second sidewall comprises a first elastic hook;
a third sidewall extending from the frame perpendicularly to the first sidewall and parallel to the second sidewall, wherein the third sidewall comprises a second elastic hook opposite to the first elastic hook of the second sidewall; and
a block extending from the frame opposite to the first sidewall.

6. The locking apparatus of claim 5, wherein each of the first and second elastic hooks comprises a guiding portion facing an opposite one of the second and third sidewalls, and a blocking portion facing the bottom wall, the first and second hooks are deformable for the magnetic member passing through.

7. The locking apparatus of claim 5, wherein a cutout is defined in each of the second and third sidewalls in the vicinity of a corresponding one of the first and second elastic hooks, for adding the elastic deformation of the corresponding one of the first and second elastic hooks.
